(19) United States
(12) Patent Application Publication
(10) Pub. No.: US 2014/0099213 A1
(43) Pub. Date: Apr. 10, 2014

(54) IRRIGATION PUMP CONTROLLER SYSTEM AND METHOD OF USE

(71) Applicant: Mattison Lee Adams, Brownfield, TX (US)

(72) Inventor: Mattison Lee Adams, Brownfield, TX (US)

(21) Appl. No.: 14/051,331

(22) Filed: Oct. 10, 2013

Related U.S. Application Data
(60) Provisional application No. 61/711,778, filed on Oct. 10, 2012.

(51) Int. Cl. A01G 25/16

(52) U.S. Cl. CPC A01G 25/16
USPC 417/63

(57) ABSTRACT

Disclosed herein is an invention directed to a system and method of use directed to a pivot irrigation control system utilizing cellular short messaging service (SMS) to communicate between the various elements of the system to provide status updates and controls of the elements within the system. In one embodiment, the pivot irrigation control system is comprised of a well controller element, at least one pump controller element, and an input/output element. The well controller element is communicatively coupled with the pump controller element(s) and the input/output element. In another embodiment, the controller element, the pump controller element(s), and the input/output element are all communicatively coupled with each other for the purpose of relaying the status of each element. In one embodiment the communicatively coupling is achieved through SMS communications between the elements.

### CROSS-REFERENCE TO RELATED APPLICATIONS

This application claims the benefit under Title 35 United States Code §119(e) of U.S. Provisional Patent Application Ser. No. 61/711,778; Filed: Oct. 10, 2012, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use directed to a pivot irrigation control system. More specifically, the present invention generally relates to a system and method of use directed to a pivot irrigation control system utilizing cellular short messaging service (SMS) to communicate between the various elements of the system.

### BACKGROUND OF THE INVENTION

Without limiting the scope of the disclosed system and method, the background is described in connection with a novel system to efficiently and effectively monitor and control a pivot irrigation system.

The field's prior art reflects many approaches and systems in addressing this issue with monitoring and controlling pivot irrigation systems. Many of these prior art references utilize hard wiring or other communication means that introduce communication issues such as interference or disconnects in communications.

With the introduction of global positioning systems and the internet have evolved a number of complex irrigation control systems to help growers manage and control their crops without setting foot in the field. There are, however, a couple of disadvantages associated with these systems. One disadvantage is that many of the existing configurations are complex and sophisticated, making them prone to glitches and failures. Another issue is that many of them are expensive due to their components, complexity of setup, and maintenance and thus cost prohibitive for certain operators.

Many of the currently existing systems, especially with regard to management and control of pivot irrigation systems, are dependent upon certain radio frequency (RF) ranges for communications. With these systems, a radio frequency signal is sent to the grower, alerting of a status change. The user can then send a control command back causing the well to turn off or on. To implement these systems, kill wire must be buried from each well to the pump. This is an expensive and labor intensive process that is subject to frequent breakdown if the kill wire becomes damaged or compromised by animals or by elements such as lightning. Another disadvantage of these radio frequency based systems is that, because there are so few available RF channels in these ranges, your system may inadvertently control your neighbor's system and vice versa. More sophisticated systems exist, incorporating the internet, servers and email communications, but these systems are typically quite expensive due to their components, complexity of setup, and maintenance.

While all of the aforementioned systems and methods may fulfill their unique purposes, none of them fulfill the need for a practical, effective, and efficient means for controlling a pivot irrigation system.

Therefore, the present invention proposes a novel system and method of use directed to a pivot irrigation control system utilizing cellular short messaging service (SMS) to communicate between the various elements of the system to provide status updates and controls of the elements within the system.

### BRIEF SUMMARY OF THE INVENTION

The present invention, therefore, provides a system and method of use directed to a pivot irrigation control system utilizing cellular short messaging service (SMS) to communicate between the various elements of the system to provide status updates and controls of the elements within the system.

It is an objective of the disclosed invention to provide a more reliable system for controlling well pumps associated with pivot irrigation systems.

It is an objective of the disclosed invention to provide a less expensive system for controlling well pumps associated with pivot irrigation systems.

It is an objective of the disclosed invention to control pivot irrigation wells through the use of cellular frequency communication systems.

It is an objective of the disclosed invention to enable communications for direct control of a pivot irrigation controller to a well pump with feedback.

It is an objective of the disclosed invention to enable direct alert, control, and feedback communication of a pivot irrigation controller to a well pump using cellular SMS communications.

In one embodiment, the pivot irrigation control system is comprised of a well controller element, at least one pump controller element, and an input/output element. The well controller element is communicatively coupled with the pump controller element(s) and the input/output element. In another embodiment, the controller element, the pump controller element(s), and the input/output element are all communicatively coupled with each other for the purpose of relaying the status of each element. In one embodiment the communicatively coupling is achieved through SMS communications between the elements. In yet another embodiment of the pivot irrigation control system, the well controller element is attached or near the pivot unit.

In summary, the present invention discloses a system and method of use directed to a pivot irrigation control system. More specifically, the present invention generally relates to a system and method of use directed to pivot irrigation control systems utilizing cellular short messaging service (SMS) to communicate between the various elements of the system to provide status updates and controls of the elements within the system.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system layout view of the irrigation pump controller system in accordance with embodiments of the disclosure;

FIG. 2 is a pump controller element layout view of the irrigation pump controller system in accordance with embodiments of the disclosure;

FIG. 3 is a well controller element view of the irrigation pump controller system in accordance with embodiments of the disclosure;

FIG. 4 is a functional diagram of the pump controller element and the well controller element of the irrigation pump controller system in accordance with embodiments of the disclosure.

### DETAILED DESCRIPTION OF THE INVENTION

Disclosed herein is a novel and improved system and method of use directed to a pivot irrigation control system utilizing cellular short messaging service (SMS) to communicate between the various elements of the system to provide status updates and controls of the elements within the system. The numerous innovative teachings of the present invention will be described with particular reference to several embodiments (by way of example, and not of limitation).

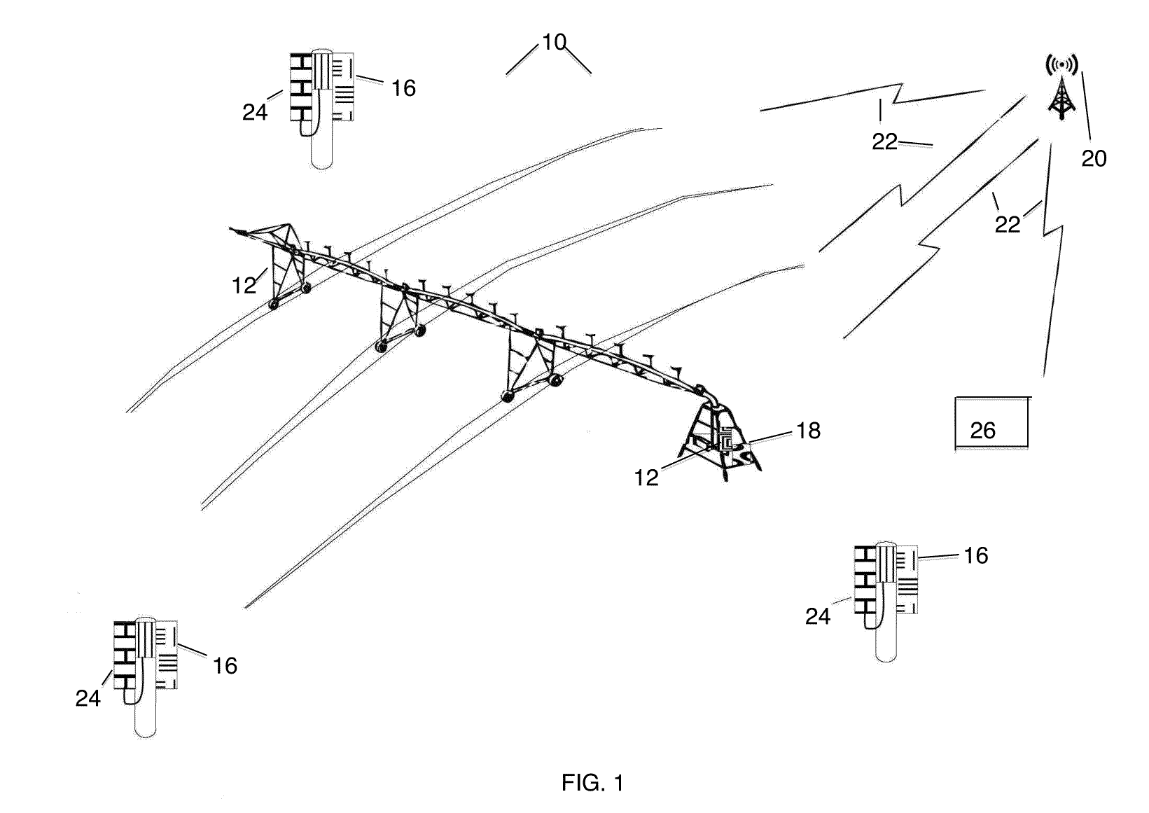

Reference is first made to FIG. 1, a system layout view of the irrigation pump controller system 10 in accordance with embodiments of the disclosure. Illustrated in this figure are the elements of the disclosed system 10. In one embodiment, the pivot irrigation control system is comprised of a well controller element 18, at least one pump controller element 16, and an input/output element 26. In another embodiment, the well controller element 18, the pump controller element(s) 16, and the input/output element 26 are all communicatively coupled with each other for the purpose of relaying the status of each element and performing certain functions such as turning off and on controlled elements such as a well pump 24 or the pivot irrigation unit 12. In one embodiment the communicatively coupling is achieved through SMS communications 22 between the well controller element 18, the pump controller element 16, and the input/output element 26. This is accomplished through the use of existing infrastructure such as cell towers 20 and cell service provided by carriers. Shown in this figure is a pivot irrigation unit 12 in operation along rows in a field. As is becoming more common, multiple well pumps 24 feed a single pivot irrigation unit 12. Also illustrated in this figure are three well pumps 24 feeding the pivot irrigation unit 12.

The well controller element 18 in an embodiment is attached or in close proximity to the pivot irrigation unit 12 and preferably at the pivot irrigation unit's 12 motor. The well controller element 18 receives SMS communications 22 from the pump controller elements 16 and the input/output element 26. Based on status updates from the pump controller elements 16 and/or requests from the input/output element 26, the well controller element 18 can start or stop the pivot irrigation unit 12. Starting and stopping of the pivot irrigation unit 12 may be accomplished by various means such as but no limited to shutting off the motor of the pivot irrigation unit 12 and/or disconnecting the electrical power to the pivot irrigation unit 12.

The pump controller elements 16 are attached or in close proximity to a well pump 24. And preferably at the well pump's 24 motor. In one embodiment, the pump controller element 16 receives SMS communications 22 from the well controller element 18. Based on status readings or updates from the pump controller element 16 itself and/or requests from the well controller element 18, the pump controller element 16 can start or stop the well pump 24. Starting and stopping of the well pump 24 may be accomplished by various means such as but no limited to shutting off the motor of the well pump 24 and/or disconnecting the electrical power to the well pump 24. Status readings and or updates are conditions of the well that may warrant action such as but not limited to on/off status, amp readings, and pressure readings.

The input/output element 26 receives SMS communications 22 from the well controller element 18 and the pump controller element 16. In another embodiment, the input/output element 26 is configured to receive and send SMS communications 22 with the well controller element 18 and/or the pump controller element 16. The input/output element 26 may take on various embodiments such as but not limited to mobile devices, smart pads, workstations, display interfaces, or any other form of graphical user interfaces (GUI) which allow a user to send and receive SMS communications 22.

In FIG. 1, three pump controller elements 16 are shown, each one having its own cellular phone number or communication id. The well controller element 18 is also shown at the location of the pivot irrigation unit's 12 motor. Each well controller element 18 and pump controller element 16 has its own cellular phone number or communication id. The cell tower 20 and the cellular signals that transmit the SMS communications 22 are shown.

Historically, having a pivot irrigation unit 12 with multiple water wells meant there was a need to connect the motor starters of each water well to the same on and off state of the pivot irrigation unit 12, meaning when the pivot irrigation unit 12 was turned on the well was pumping water and when the pivot irrigation unit 12 was turned off the well was automatically not pumping water. The issue with this operational protocol is that pivot irrigation units 12 often develop operational problems, such as flat tires, clogged nozzles or other functional issues. As a result, the pivot may be operating in the “on” status but may physically not be moving forward. If the well is still pumping water in this scenario, the pivot irrigation unit 12 will bog down in the mud created by the ongoing water.

Traditionally control of pivot irrigation units 12 has been accomplished by buried kill wire, direct radio frequency links, and manual intervention by human labor to turn each well on or off.

Conversely, the disclosed pivot irrigation control system 10 utilizes SMS cellular communications 22 to send communications and requests between the well controller element 18 located at the pivot irrigation unit 12, and the pump controller element 16 located at each of the wells connected to the pivot irrigation unit 12. When the pivot irrigation unit 12 has been switched to an on or off state, the well controller element 18 will either turn on or off the motors of the well pumps 24 via SMS commands sent to the each pump controller element 16. Each of the pump controller elements 16 and the well controller element 18 have unique individual cellular phone numbers or communication ids enabling them to communicate to each other using SMS. Creating a feedback loop, the well controller element 18 then reports back the status of the pump controller elements 16 and the pivot irrigation unit 12 via SMS to the input/output element's 26 phone number or communication id, which in most cases will be the cellular phone number(s) or communication id(s) of the grower or designated manager(s) or other mobile device or workstation configured to receive SMS communications 22. The user or individual utilizing the input/output element 26 can then, via reply commands sent by SMS, control the on and off state of the well controller element 18 of the pivot irrigation unit 12. In addition, in other embodiments, certain actions or functions can also be performed based on certain events of the system. For example, the pivot irrigation unit 12 can be turned off if a well pump 24 is turned off.

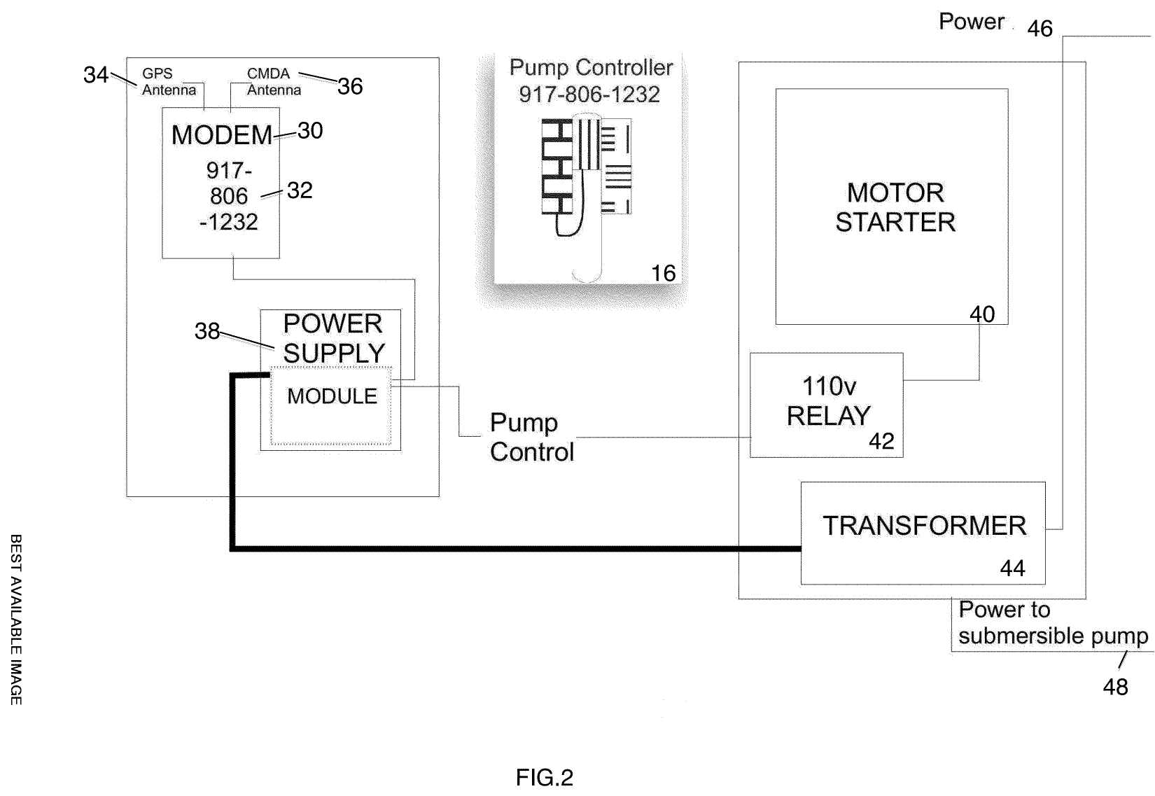

Reference is next made to FIG. 2, a pump controller element 16 layout view of the irrigation pump controller system 10 in accordance with embodiments of the disclosure. Illustrated here are the components of the pump controller element 16 which include a modem 30 having an individual cellular phone number or communication id 32, a GPS antenna 34, and a CDMA antenna 36; a power supply 38 having a motor starter 40, a 110V relay 42 and a transformer 44, all in communication with a power source 46 (typically electric energy supplied by an agricultural cooperative). In an embodiment, the pump controller 16 then delivers power and on/off control to a submersible pump 48 which pumps water to the pivot irrigation unit 12. In operation, each pump controller element 16 is connected to a water pump 48 in the pivot irrigation control system 10. The pump controller element 16 receives SMS commands to its modem 30 to turn on or off the motor starter 40 of the pump controller element 16 and then, in a feedback loop, reports the on/off status via SMS communications 22 from its modem 30 back to the modem located on the well controller element 18. In another embodiment, the SMS communications 22 may also be delivered directly to the input/output element 26 as well.

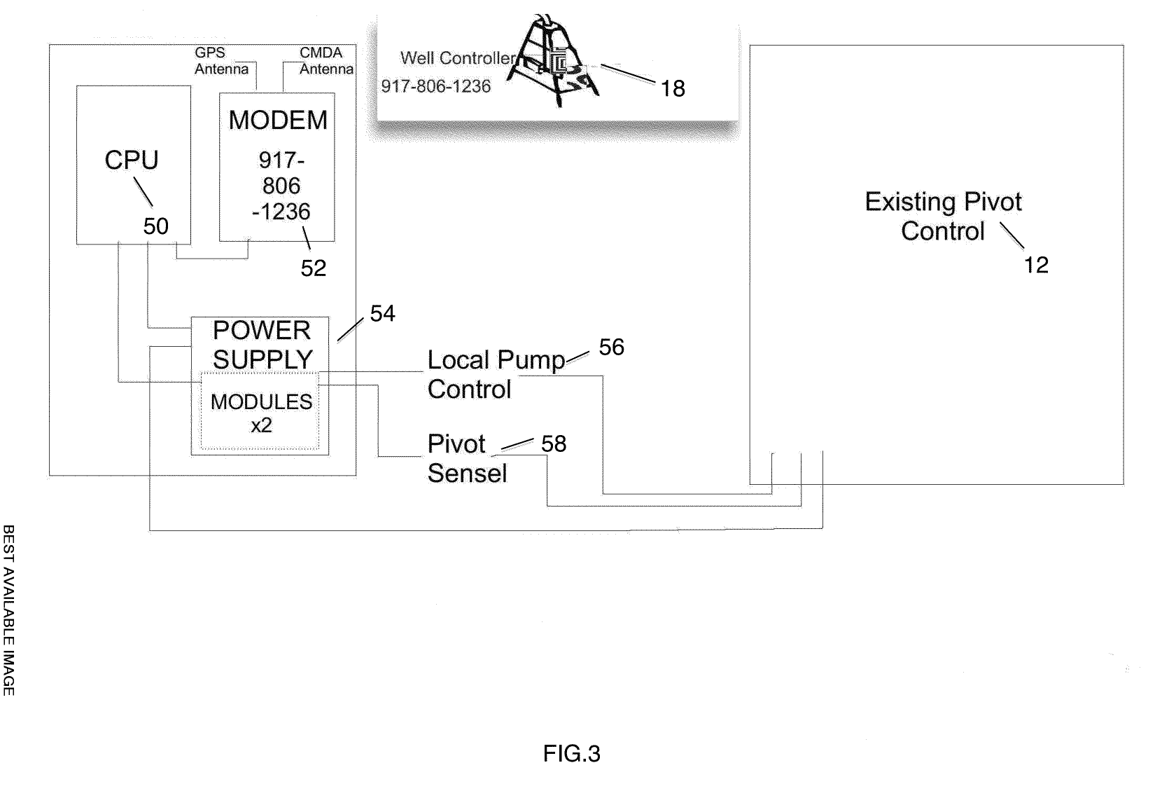

Reference is now made to FIG. 3, a well controller element 18 view of the irrigation pump controller system 10 in accordance with embodiments of the disclosure. Illustrated here are the components of the well controller element 18. The well controller element 18 has a CPU 50 a modem 52 with an individual cellular phone number or communication id, a GPS antenna, and a CDMA antenna; a power supply 54 with two modules, one feeding the local pump control 56 and one feeding the pivot sensel 58, both ultimately tied into the existing pivot irrigation unit 12 through the safety line to toggle switch.

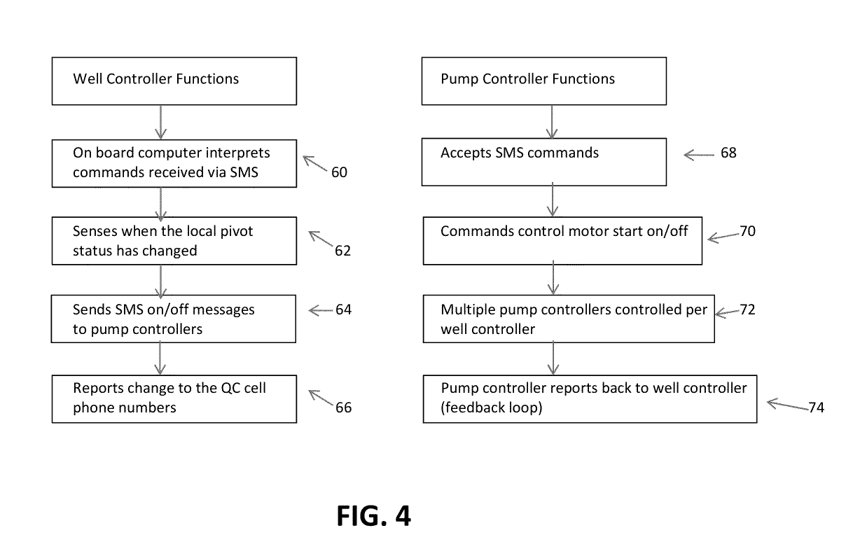

Reference is lastly made to FIG. 4 a functional diagram of the pump controller element 16 and the well controller element 18 of the irrigation pump controller system 10 in accordance with embodiments of the disclosure. FIG. 4 illustrates the functions of the components of the disclosed system. The well controller element 18 has a first function 60 wherein the well controller element 18 interprets commands received via SMS communications 22. In a second function 62, the well controller element 18 senses when the pivot irrigation unit 12 status has changed and, using a third function 64, sends SMS communications 22 on/off messages to the pump controller elements 16. As a fourth function 66, when sending SMS communication 22 control commands to the pump controller elements 16 it also sends reports of the changes to the input/output element 26.

The pump controller element 16 has a first function 68 wherein the pump controller element 16 accepts SMS communication 22 commands generated by the well controller element 18. Using a second function 70, the pump controller element 16 enables the commands received to control the well pump 24 motor start on/off. In a third function 72, multiple pump controller elements 16 are able to be controlled by one well controller element 18. In the fourth function 74, the pump controller 16 reports back to the well controller element 18, creating a feedback loop using SMS communications 22.

The necessity of the disclosed novel system has arisen with the need for multiple well pumps 24 to pump enough water to support one pivot irrigation unit 12. The well controller element 18 of the disclosed system 10 is capable of controlling all the well pumps 24 connected to the pivot irrigation unit 12. The well controller element 18 is connected to the existing pivot irrigation unit's electrical panel to obtain power and also to detect the ongoing status of the pivot irrigation unit. The user is able to configure the well controller element 18 and/or the pump controller element 16 using SMS commands from the input/output element 26.

The pump controller is connected to the various water pumps in the system. The pump controller receives SMS commands to turn on or off the motor starter of the pump and reports the on/off status via SMS back to the well controller.

Known pivot irrigation management and control systems usually incorporate communication by email, server access, online web accounts and other sophisticated means. The grower may receive a message regarding status of his pivot and then log onto a web account to send a command back to the unit. The disclosed is a greatly streamlined and simplified process that reduces cost and increases reliability by relying on a cellular communication system wherein each pump controller and well controller has their own phone number and can communicate to one another via SMS. This is far different than the known systems which alert the grower, who then sends a command back to the system. In the disclosed system, although the grower (QC phone numbers) are notified as a courtesy, the system itself communicates and controls itself by monitoring status and sending on/off commands to the water pumps as needed. The feedback loop ensures that the commands have been carried out. Essentially, the system requires no grower intervention for the tasks of turning the water well pumps on and off in response to status changes incurred by the pivot unit.

In brief, the device is directed to a system and method of use directed to a pivot irrigation control system utilizing cellular short messaging service (SMS) to communicate between the various elements of the system to provide status updates and controls of the elements within the system.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed system or method of use, except as may be outlined in the claims.

Alternative applications for this invention include using this system for other irrigation systems utilizing the cellular short messaging service (SMS) to communicate between the various elements of the system to provide status updates and controls of the elements within the system. Consequently, any embodiments comprising a one element or multi element system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific system and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A pivot irrigation control system comprising:
a well controller element comprising a CPU, a modem, a GPS antenna, and a cellular antenna coupled to the pivot irrigation unit to perform starting and stopping functions of the pivot irrigation unit and is communicatively coupled to other elements of the system;
a pump controller element comprising a modem, a GPS antenna, a cellular antenna, and a transformer coupled to the well pump to perform starting and stopping functions of the well pump and is communicatively coupled to other elements of the system;
an input/output element communicatively coupled with other elements of the system.

2. The system of claim 1, wherein the cellular antennas are CDMA antennas.

3. The system of claim 1, wherein cellular short messaging service (SMS) is utilized for communicatively coupling to send and receive communications between the system elements.

4. The system of claim 1, wherein the well controller element also comprises a power supply with two modules, one feeding the pump controller and one feeding the pivot sensel, both ultimately tied into the existing pivot irrigation unit through the safety line to toggle switch.

5. The system of claim 1, wherein the pump controller also comprises a power supply having a motor starter, a 110V relay, and a transformer.

6. The system of claim 1, wherein the input/output element is a mobile device.

7. The system of claim 1, wherein the input/output element is a workstation.

8. The system of claim 1, wherein the input/output element is a graphical user interface configured to send and receive SMS communications.
